(19) United States
(12) Patent Application Publication
(10) Pub. No.: US 2004/0070691 A1
(43) Pub. Date: Apr. 15, 2004

(54) Image processing method of sporting events

(76) Inventors: Akio Kojima, Tokyo (JP); Kazuo Ohtake, Saitama (JP)

Correspondence Address: REED SMITH LLP, Suite 1400, 3110 Fairview Park Drive, Falls Church, VA, 22042, US

(21) Appl. No.: 10/268,995

(22) Filed: Oct. 11, 2002

(51) Int. Cl. H04N 9/76

(52) U.S. Cl. 348/601; 348/157

(57) ABSTRACT

An image processing method for sporting events including golf and ski jump, in which an event parameter or variable or the athlete is to reach a predetermined position, wherein electronically processed marker images including lines, drawings, symbols, and colors are overlaid on the original image at a point close to said predetermined position or at multiple points, each distant from said position. This allows TV viewers to see, for example in a golf match, how far the ball is driven and how close the ball is to the cup on the green, as well as the flight of the ball.

### BACKGROUND OF THE INVENTION

1. Technical Field

The invention relates to an image processing method for sporting events, and more particularly to an image processing method capable of processing, for example, TV images, using a computer to help viewers enjoy more sporting events. TV viewers will find it an attractive feature if they can see, for example, how close to the pin the ball has approached in a golf or gate-ball match, or how close to the world record the athlete has performed (shot, jumped) in track and field games such as the shot-put and long jump, and whether the jumper has reached the K-point in ski jump, in real-time while watching TV. The present invention enables TV viewers to enjoy sporting events in such ways.

2. Prior Art

Among sporting image processing methods using computers, U.S. Pat. No. 5,857,855 is known to the public as such a method for golf and other sports. In this invention, the form image of a professional player and that of an amateur player are shown in parallel on the TV screen, and an instructor, for example, a professional golfer, corrects the armature's form using lines and text on the screen. Meanwhile, it is a popular technique to draw the path of a professional golfer's shot to get interest viewers by demonstrating how skillfully he has overcome the course.

In a golf tournament on TV, for example, it would greatly add to the viewers' interest in the TV screen if they could see how close (in meters or centimeters) the ball is to the pin when the ball land on the green (Nice On) and rolls close to the pin. Likewise, in the long jump, discus throw, and shot-put, if viewers can see world and Olympic records or the results for the preceding athlete or thrower in real-time on the TV screen, they will follow events with greater interest. Furthermore, if the viewers can see on the TV screen a line indicating the K-point and see whether the ski jumper has reached the K-point across this line in real-time, this would also augment viewer response.

One of the aspects of the present invention is to provide a method for processing sporting images that meets the above needs. More specifically, the invention enables TV viewers to see—for example, in a golf match—the path and distance of a driver shot and to see how close the ball is to the pin on a green along with the path of the ball. In the shot-put, javelin throw, discus throw, long jump, or hop-step-jump, for example, the invention indicates world and Olympic records on the TV screen with symbols or graphic characters to allow viewers to judge a performance or determine if a new record is in the midst of being established. Likewise, for example in the ski jump, the invention displays a drawing or symbol indicating the K-point of the jump course on the TV screen together with the image of the jump itself, so that viewers can enjoy the jumps while referring to such marks, characters, and drawings.

### SUMMARY OF THE INVENTION

The present invention is an image processing method for sporting events including golf and the ski jump, in which an event parameter or variable or the athlete is to reach a predetermined position, wherein electronically processed marker images including lines, drawings, symbols, and colors are overlaid on the original image at a point close to said predetermined position or at multiple points distant from said position.

Another aspect of the invention is that marker images including drawings, symbols, and colors are not overlaid on the event parameter or variable or athlete.

Another aspect of the invention is an YES or NO function for determining whether to overlay marker images including drawings, symbols, and colors on the original image, and a means for calling the desired marker image for the sport, adjusting the scale and view angle thereof to those of the original image, and overlaying the marker image on the original image.

Another aspect of the invention is to detect the position(s) of the athlete and/or event parameter or variable and extract the area thereof on the original image, thereby removing the marker images overlaid on the athlete and event parameter or variable upon said image overlays.

Another aspect of the invention is that the detection of the position(s) of the athlete and/or event parameter or variable is conducted for both moving images and still images.

These and other features and advantages of the present invention will become apparent from the following embodiments, with reference to the accompanying drawings:

### BRIEF DESCRIPTION OF THE DRAWINGS

FIG. 1 is a function block diagram illustrating TV-image processing as an embodiment of the system according to the present invention.

FIG. 2 is a function block diagram illustrating another TV-image processing according to the invention.

FIG. 3 is a perspective view illustrating an application of the invention to the view of a golf course.

FIG. 4 is a perspective view illustrating an application of the invention to the view of a golf green.

FIG. 5 is a perspective view illustrating an application of the invention to the view of the long Jump where a marker image is overlaid.

FIG. 6 is a perspective view illustrating the original image of the above long jump.

FIG. 7 is a perspective view illustrating an application of the invention to the view of a ski jump.

### DETAILED DESCRIPTION OF THE PREFERRED EMBODIMENTS

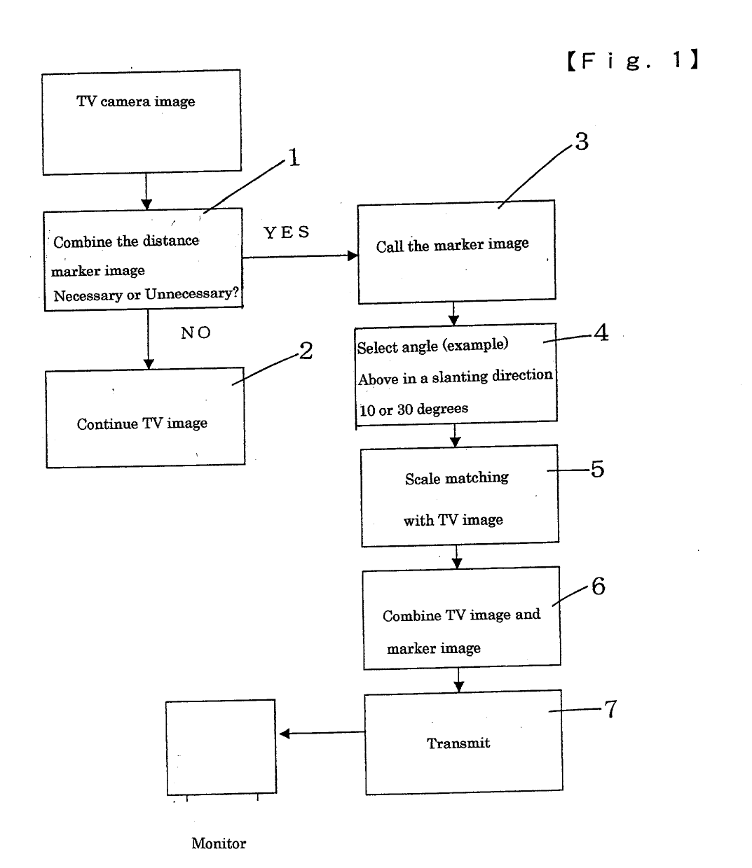

Referring now to FIG. 1, one of the embodiments of the invention executes predetermined image processing in accordance with programs stored on devices such as a CD-ROM, hard drive, or DVD.

Such programs may include the following:

1. A program for golf events that shows lines and number markers on the TV screen for distances, such as 200, 250, 300, and 350 yards from the tee line toward the green.

2. A program for golf events that draws circle markers in the green shown on the TV screen; the circle markers drawn concentrically around the pin at intervals of 1, 3, 5, 8, and 10 meters, for example.

3. A program for the shot-put, discus throw, and javelin throw that shows on TV certain markers in the field at predetermined intervals across the world and Olympic records in plus(+) and minus(−) directions.

4. A program for the ski jump that shows markers at predetermined intervals across the K-point in plus(+) and minus(−) directions.

5. A program for selecting whether to overlay such markers onto the on-going TV video image or not.

6. A program for terminating the display of such markers and displaying the TV video image as it is, when decided not to show such markers.

7. A program for selectively invoking the above 1-4 programs and overlay the marker image onto the TV video image in this embodiment when decided to show the markers on the TV video image.

8. A program for showing the markers at the same level as the ground level with a selected slanting view angle of 10-30 degrees.

9. A program for matching the scale of the markers with the detected scale of the green, for example, in a golf event.

10. A program for overlaying the scale-adjusted markers onto the TV video image.

11. A program for transmitting the TV video image combined with the markers.

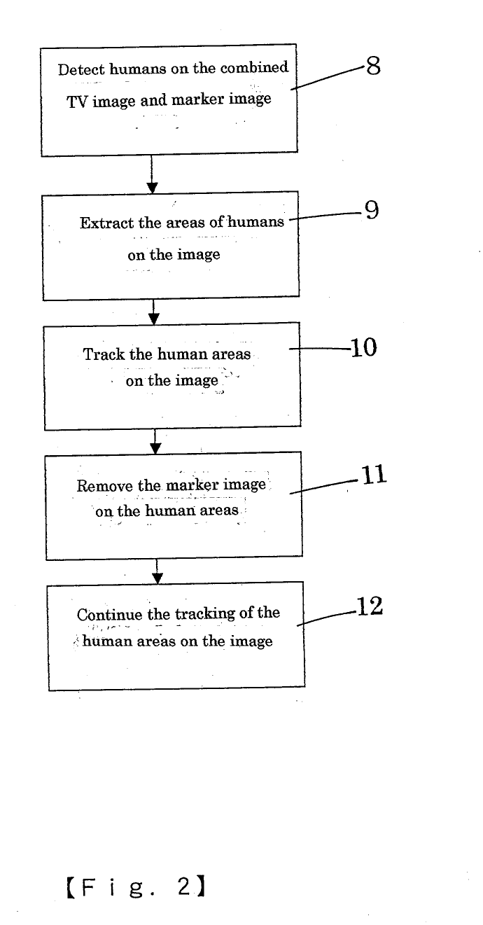

In addition to the above, the present invention embodies certain improvements. As shown in the flowchart for FIG. 2, the invention also includes the following programs:

12. A program for detecting objects such as humans, trees, and buildings in the TV image when combining the TV video image with markers.

13. A program for extracting areas occupied by such humans, trees, and buildings in the TV image.

14. A program for tracking the areas of such extracted objects, in particular, those resembling humans in motion.

15. A program for removing the marker overlaid on such humans, for example, that are extracted and/or tracked.

16. A program for continuing the tracking of humans even after markers have been removed therefrom.

(Embodiment 1)

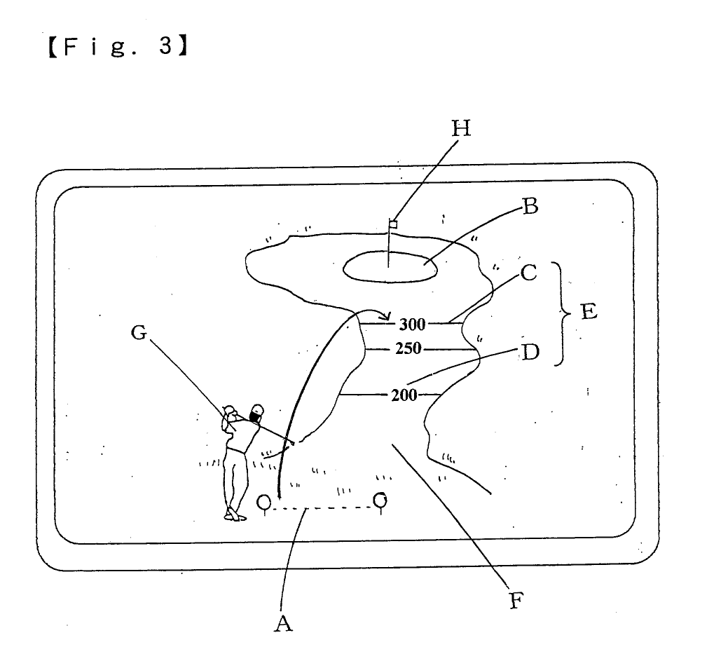

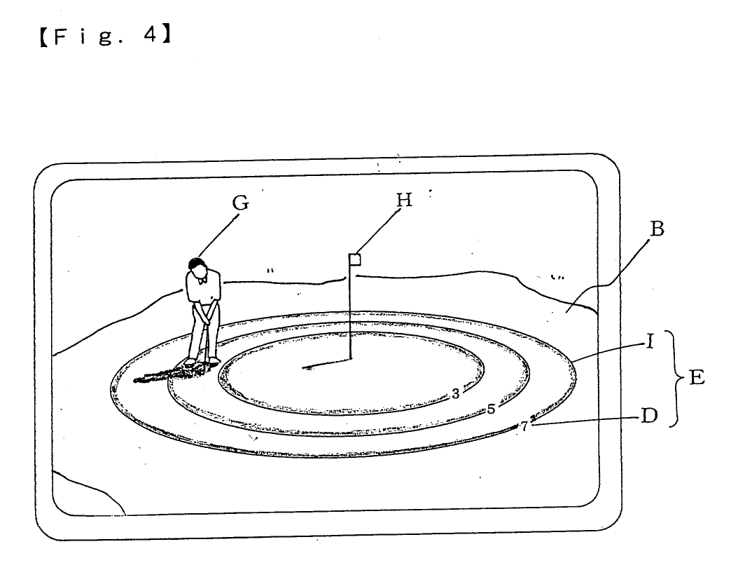

FIGS. 3 and 4 show golf play; FIG. 3 illustrates a ball shot from the tee of a middle hole toward the green and landing on the fairway; while FIG. 4 illustrates the ball on a green.

Prior to the display of the above scenes on TV, the image processing method of the present invention activates the following programs. Referring now to FIG. 3, it invokes a program that provides the marker image (E) having the line image (C) indicating distances 150, 200, 250, and 300 yards from the tee ground (A) to the green (B) and numbers (D) in Step (3), and then sets the marker image at Necessary.

When set to Unnecessary, the program disables the above function in Step (2) to show normal TV video images as they are, with no marker image (E).

When set to Necessary (YES) in Step (1), the above marker image (E) is shown as FIG. 3. In this case, however, the marker image (E) is rarely shown on the same plane as the fairway (F) if no adjustment is provided. Thus, an installed program corrects (4) the view angle of the marker image (E) so that the image (E) matches the ground surface.

Further, the scale of the marker image (E) should agree with those of the fairway (F) and the green (B). For this purpose, the scales of the fairway (F) and green (B) are detected in Step (5), and the scale of the marker image (E) is adjusted thereto.

As a result, the marker image (E) matches the image of the fairway (F) under similar scales, and the image of the fairway (F) combined with the marker image (E) is made ready for transmission. In this way, TV viewers can see the fairway (F) and green (B) with the marker image (E) overlaid as shown in FIG. 3, as necessary. As a result, viewers will vividly experience the skill of a professional golfer who drives the ball beyond 200, 250, or 300 yards, as well as the athlete's form.

On the image of the green (B), meanwhile, the graphics shown in FIG. 4 are drawn by a program that draws the concentric circle markers (I) indicating distances such as 1, 3, and 5 meters from the pin (H). This allows viewers to see that the ball shot from the fairway (F) has landed on a spot on the green (B) 10 m from the pin, and how close (in meters) the ball is to the pin (H) by watching the numbers (D) indicating the distance from the pin.

(Embodiment 2)

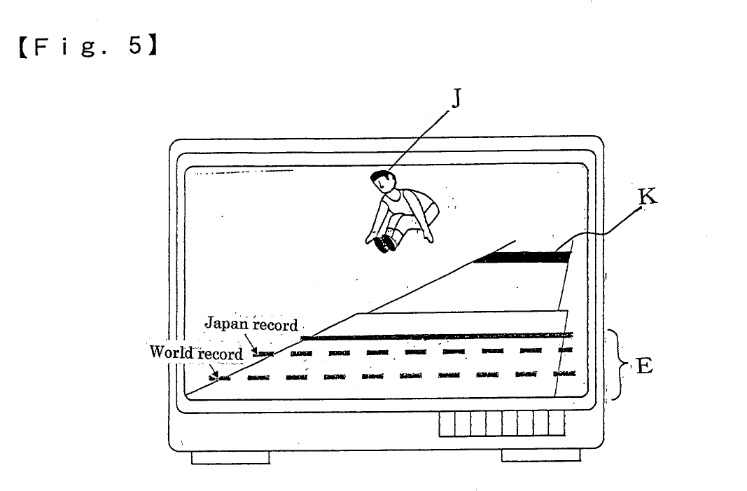

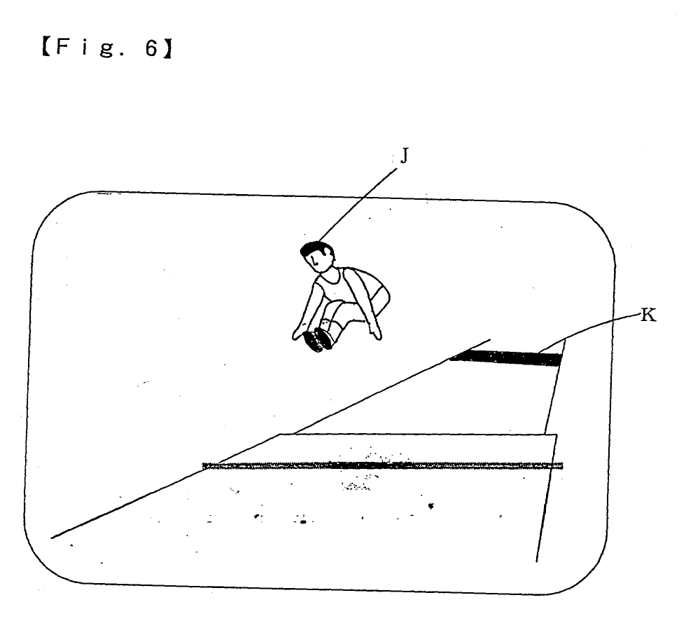

The present invention can also be applied to sports other than golf, enhancing viewing for TV viewers watching sporting events such as the shot-put, discus throw, or javelin throw. FIGS. 5 and 6 show an example of the present invention applied to a scene of the long jump. FIG. 6 shows the original image with no marker image, while FIG. 5 shows an image where a marker image has been combined with the original image. If a program shows the lines corresponding to the world and Olympic records and markers drawn across those lines at predetermined intervals in the plus (+) and minus (−) directions along the jumper (J)'s jumping direction from the beat board (K), the viewers can instantaneously see and follow whether the jumper has achieved a world or Olympic record, even without audio, at the moment of the performance.

(Embodiment 3)

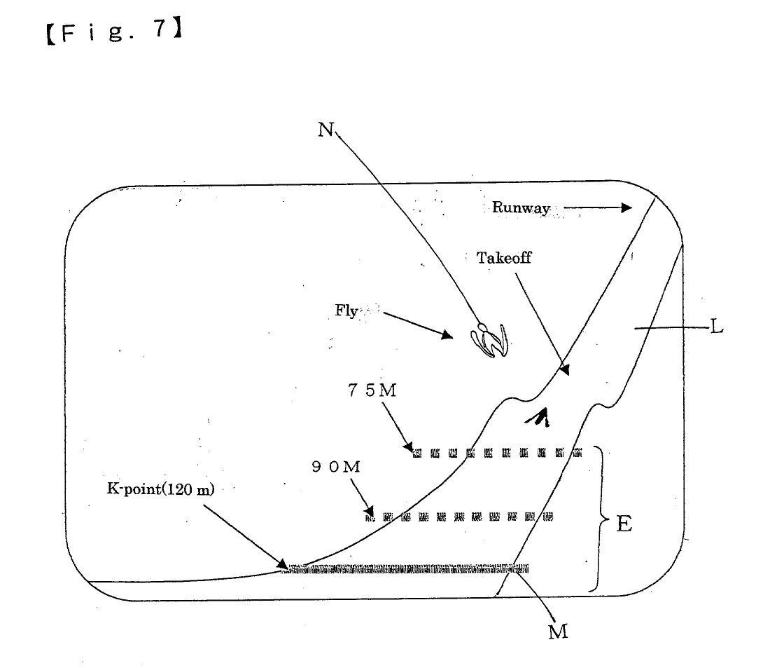

FIG. 7 illustrates an example of the invention applied to image processing for ski jump. The invention has a program capable of drawing markers on the screen at predetermined intervals across the K-point (M) in the plus (+) and minus (−) directions. Activating this program, the invention superimposes the marker image in the TV video image of the jump and conducts view angle and image scale adjustments. The illustrated example assumes a 120 m K-point (M) and draws the marker image (E) indicating the 75 m and 90 m lines in the direction of the jump. This allows viewers to see a jumper (N) flying over the 75 m line, 90 m line, and then the 120 m K-point in real-time, referring to the marker image (E), thereby enhancing interest.

On the other hand, the program must avoid overlaying marker image (E) such as lines on the original TV image, particularly those of the player, when superimposing a marker image (E). Thus, before implementing the present invention, it is important to activate a program as shown in FIG. 2 for extracting (8) humans, trees, and buildings in the TV image when combining the TV image and a marker image.

At the same time, the invention invokes a program for extracting (9) areas occupied by humans, trees, and buildings in the TV image and activates a program for tracking (10) such areas if the extracted area is a moving image, primarily of a human in motion.

Subsequently, the invention activates a program for removing (11) only the marker image overlaid onto the extracted and/or tracked human area. Even after such marker image has been removed, the invention continues to run the program for tracking the moving player.

As a result, in FIG. 4 where circles (I) of the marker image (E) are drawn in the green (B), there is no overlay of circles (I) of the marker image (E) on the player (G). Thus, there is no risk of creating an impression of strangeness among TV viewers.

When implementing the present invention, it is also important to track the player (G) in motion and prevent the marker image (E) from overlaying the moving player (G) or his shadow.

In brief, the invention allows TV viewers to see with significantly higher clarity and interest than ever before the driver carry, the landing position of the ball on a green, and putting performance with reference to the distance to the pin when watching a golf event or otherwise on TV. Likewise, they can see and enjoy an athlete's performance with reference to the world and Olympic records in a long jump, discus throw, or shot-put, for example, since such records and the results for the preceding athlete are displayed on the TV screen in real-time. Further, for a ski jump, TV viewers can see whether the jumper has passed over the K-point in real-time, since a reference line is drawn beforehand in the K-point on the screen. In addition, viewers can enjoy sports programs on TV without marker images overlaid on players.

What is claimed is:

1. An image processing method for sporting events including golf and ski jump in which an event parameter or variable or the athlete is to reach a predetermined position,
wherein electronically processed marker images including lines, drawings, symbols, and colors are overlaid on the original image at a point close to said predetermined position or at multiple points, each distant from said position.

2. The method according to claim 1, wherein marker images including drawings, symbols, and colors are not overlaid on the event parameter or variable or athlete.

3. The method according to claim 1 or 2, comprising:
a YES or NO function of deciding whether or not to overlay marker images including drawings, symbols, and colors on the original image; and
a means for calling the desired marker image for the sport, adjusting the scale and view angle thereof to those of the original image, and overlaying the marker image on the original image.

4. The method according to claim 3, the method detecting the position(s) of the athlete and/or event parameter or variable and extracting the area thereof on the original image so as to remove the marker images overlaid on the athlete and event parameter or variable upon said image overlays.

5. The method according to claim 4, the detection of position(s) of the athlete and/or event parameter is conducted not only on their still images, but on moving images.
